(19) United States
(12) Patent Application Publication
(10) Pub. No.: US 2019/0054910 A1
(43) Pub. Date: Feb. 21, 2019

(54) BRAKING DEVICE FOR A HYDRAULIC MOTOR VEHICLE BRAKE SYSTEM

(71) Applicant: Continental Teves AG & Co. oHG, Frankfurt (DE)

(72) Inventor: Lothar Schiel, Hofheim (DE)

(21) Appl. No.: 15/763,647

(22) PCT Filed: Sep. 29, 2016
(86) PCT No.: PCT/EP2016/073357

§ 371 Date: Mar. 27, 2018

(30) Foreign Application Priority Data
Oct. 2, 2015 (DE) 10 2015 219 126.5

(51) Int. Cl. B60T 13/14; B60T 13/58; B60T 17/00; B60T 15/36; B60T 11/16; B60T 13/74

(52) U.S. Cl. CPC B60T 13/146; B60T 13/58; B60T 17/00; B60T 2270/82; B60T 11/165; B60T 13/745; B60T 2270/404; B60T 15/36

(57) ABSTRACT

A braking device for a hydraulic motor vehicle brake system, with an energy-store-free, electronically controlled electric-motor-driven on-demand braking force booster and with a master brake cylinder, in which, for the purpose of reducing the foot force on the brake pedal in the fall-back level, the braking pressure in the pressure chamber is built up stepwise and at least one active surface involved in generating brake pressure is switchable so as to be hydraulically ineffective.

### CROSS REFERENCE TO RELATED APPLICATIONS

This application is the U.S. National Phase Application of PCT International Application No. PCT/EP2016/073357, filed Sep. 29, 2016, which claims priority to German Patent Application No. 10 2015 219 126.5, filed Oct. 2, 2015, the contents of such applications being incorporated by reference herein.

### FIELD OF THE INVENTION

The invention relates to a brake device for a hydraulic motor vehicle brake system having an on-demand brake booster.

### BACKGROUND OF THE INVENTION

In order to generate a necessary braking force in hydraulic motor vehicle brake systems it is generally known to use different brake boosters which pass on the muscle force of the driver in boosted form to a master brake cylinder connected downstream, or which generate force autonomously in an electronically controlled fashion. Such brake boosters require, for the boosting process, hydraulic, pneumatic, electrical or mechanical energy or a combination thereof, depending on the design.

With the aim of reducing the energy consumption and emissions of pollutants of a motor vehicle, efforts are made to make the brake boosters as compact, lightweight and economical in terms of energy as possible. Therefore, brake boosters are being increasingly used with separate, usually electric-motor-powered drive to generate the required energy, which drive is activated only when actually needed. For reasons of weight and costs, additional energy stores such as, for example, high-pressure accumulators, vacuum accumulators and spring-type actuators and the like are dispensed with. Such energy-store-free brake boosters whose energy is supplied in an acute fashion, exclusively by the assigned drive, are also referred to as on-demand brake boosters.

The use of such on-demand brake boosters has the result that in the event of a malfunction of the drive or of a primary energy source which feeds the drive the boosting force cannot be retrieved and the system drops back into the lowest fall-back level immediately and without warning where the vehicle has to be braked merely by the muscle force of the driver. Because the hydraulic master brake cylinder must meet the volume demand of the brake system, said master brake cylinder has a relatively large effective diameter which is configured for that purpose. So that the driver can also physically bring about a sufficient deceleration in an emergency, a maximum permissible foot force is prescribed. However, the upper limit of, for example, 500N is significantly higher than the customary, usual application of force. However, there is a risk of the driver being surprised by a suddenly increased demand for an application of force and does not bring about a necessary braking deceleration in good time. An energy store would in such a case still be able to make available energy for power boosting for a limited time, but is not available.

In order to solve this problem, combined braking devices of an integrated design are known in which two separate and unconnected activation cylinders with respective different effective diameters are provided for the fall-back level and the service braking. Here, in the event of a power failure, the driver uses a pedal cylinder with a particularly small effective diameter, in order in this way to achieve relatively high braking of the vehicle with legally limited foot force. However, such a system is complex, and in addition the expenditure on the adaptation to different vehicle applications is associated with structural complexity which needs to be reduced.

DE 10 2014 202 373, which is incorporated by reference discloses a stand-alone master brake cylinder without a brake booster and with large effective diameter which can be switched off and which is actuated for usual service braking operations solely by the muscle force of the driver, and is additionally assisted by a downstream, electronically regulated modulator unit for driving stability-control functions only in the case of strong braking operations and emergency braking operations. Such a system is, however, suitable, in particular, for vehicles with a low vehicle mass.

### SUMMARY OF THE INVENTION

An aspect of the invention therefore arises by offering an improved brake device with an on-demand brake booster, which in the event of a malfunction or failure of the boosting force reduces the effects on the driver and permits safe braking with permissible pedal forces and pedal travel even in the case of relatively heavy vehicles.

Both the foot force at the brake pedal and the pedal travel can be reduced overall by incrementally building up the brake pressure in the pressure chamber of the master brake cylinder, in the case of a unusual braking operation, for example a case for failure of the drive unit of an on-demand brake booster.

In an emergency, the driver is provided with a reduced active area on the piston in the master brake cylinder, which active area permits him to achieve a sufficient braking deceleration up to prescribed full braking deceleration (in particular 0.643 g) with the foot force below the permissible upper limit (in particular 500N).

In the case of continued activation at relatively high brake pressures in the pressure chamber of the master brake cylinder, a relatively small active area becomes hydraulically effective, as result of which the upper limit for the foot force is not exceeded.

In order to compensate the relatively small expelled volume of the pressure medium by means of the relatively small active area, a significantly larger active area becomes additionally hydraulically effective at the start of the activation and is switched to a hydraulically ineffective setting as a function of the pressure.

This switching over or switching off can take place here in a fail-safe fashion, forcibly without electrically actuated valves, can be active whenever activation occurs and can be adapted through structural configurations of the prestress to different pressures.

The switching over is advantageously implemented by means of a valve assembly with a spring-loaded valve piston which closes or opens, under pressure control, a hydraulic connection between a filling stage chamber assigned to the relatively large active area in the master brake cylinder with the pressureless pressure medium container.

In this context, the valve assembly can be arranged in different inventive embodiments both in the piston and in the housing of the master brake cylinder.

In a usual braking process with a brake booster which is functioning satisfactorily, the incremental pressure build up is compensated by the control of the drive unit or of the brake booster, with the result that the driver does not feel any effects at the brake pedal.

An aspect of the invention can be adapted to the proven tandem master brake cylinder technology cost-effectively and with low development expenditure.

A modular design by means of a combination of suitable embodiments of brake boosters and master brake cylinders at a preferably standardized interface is made possible, as result of which different variants can be easily generated.

A master brake cylinder can thus be mounted in a conventional way on the housing of the brake booster and effectively connected thereto via a preferably standardized interface.

In this context, both hydraulic and mechanical, electrical, pneumatic and combined on-demand brake boosters can be used.

There is no need for a larger installation space, and the electrical, hydraulic and mechanical interfaces can also be combined with conventional brake devices.

Additional electronic monitoring of the brake device is not necessary, and since the incremental buildup of brake pressure is continuously active and it does not have to be additionally activated in an emergency.

### BRIEF DESCRIPTION OF THE DRAWINGS

Further details, features, advantages and application possibilities of the invention can be found in the subclaims together with the description with reference to the drawings. Corresponding components and structural elements are provided with the same reference signs where possible. In the drawings:

FIG. 1 shows a simplified illustration of an embodiment of the brake device according to the invention with a master brake cylinder in a tandem design and a single-stage piston.

FIG. 2 shows a simplified illustration of a further inventive embodiment of the brake device with another master brake cylinder with a two-stage piston.

FIG. 3 shows a diagram showing the ratio between the foot force and the braking deceleration in the usual operating mode and in the fall-back level with active areas of different sizes.

### DETAILED DESCRIPTION OF THE PREFERRED EMBODIMENTS

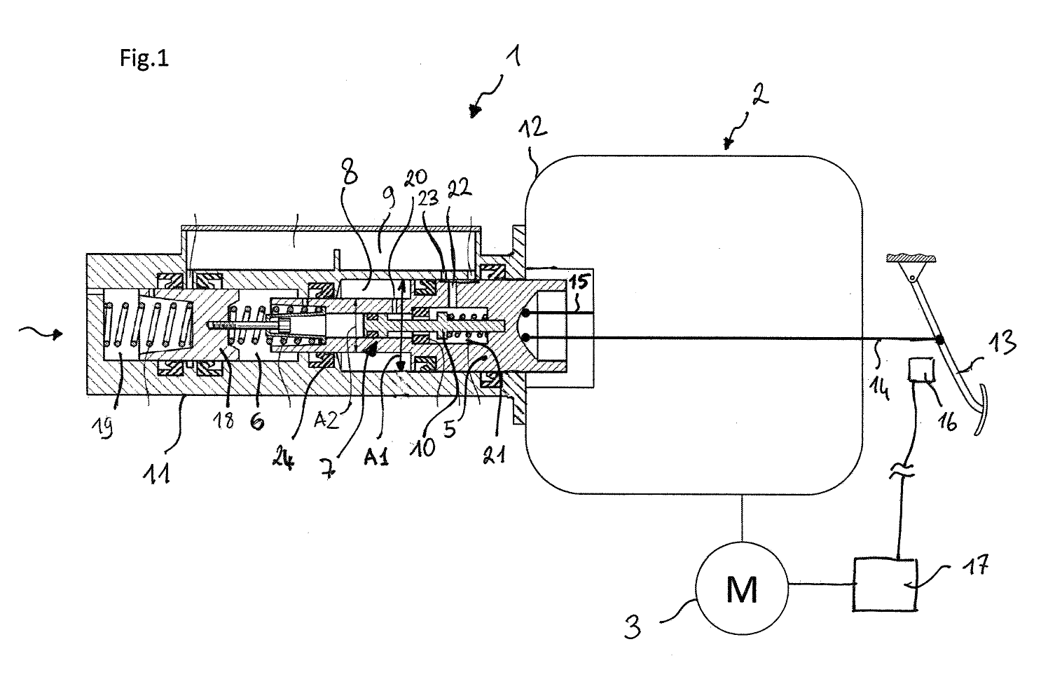

### FIG. 1:

The brake device 1 comprises a master brake cylinder 4 which is filled with pressure medium and is mounted on the housing 12 of a brake booster which is illustrated only schematically. The brake booster 2 is driven by an electric-motor-powered drive unit 3 according to the on-demand principle. Here, the brake booster 2 draws the energy which is required to generate a boosted braking force exclusively from the drive unit 3 during its operation and does not have a separate energy store which would ensure the supply of energy when a drive unit is deactivated.

The control of the brake booster 2 is carried out by an electronic control unit 17.

During the usual operation of the brakes, the brake booster 2 provides the brake force via a coupling device 15 to the piston 5, connected downstream, of the master brake cylinder 4.

When the energy supply fails or there are other faults during which the brake booster 2 cannot function satisfactorily—in the so-called fallback level—the piston 5 is activated directly by the brake pedal 13 via the coupling device 14 solely by the muscle force of the driver.

The two coupling devices 14, 15 can also be combined within the invention designed as a common coupling device.

Likewise, a simulator unit (not shown here), which generates a haptic feedback to the brake pedal 13 during the use of the brake booster 2 can be provided within an aspect of the invention, in the effect chain between the brake pedal 13 and the piston 5.

A sensor device 16 registers the braking actions of the driver in the normal braking mode and communicates it to the electronic control unit 17 for the purpose of corresponding actuation of the drive unit 3 or of the brake booster 2.

The piston 5 is displaced to be mounted in the housing 11 of the master brake cylinder 4 and bounds a pressure chamber 6 which is connected to a brake circuit (not shown). In the embodiment shown, the piston 5 is embodied as a stepped piston with two steps. When the piston 5 is displaced in the direction of the pressure chamber 6, the first step with the relatively large active area A1 and the second step with the relatively small active area A2 are involved in a hydraulically effective fashion in the buildup of the brake pressure in the pressure chamber 6. While the active area A2 is acting exclusively in the pressure chamber 6, the active area A1 expels the pressure medium from a separate filling stage chamber 8 passed the direction-dependent ceiling element 24 and into the pressure chamber 6.

A valve arrangement 7 with a valve piston 10 which is spring-loaded at the rear is arranged in the piston 5. At the start of the braking operation, the valve arrangement 7 is closed. However, as soon as the brake pressure in the pressure chamber 6 has reached a defined value which exceeds the spring load, the valve piston 10 moves counter to the spring load, with the result that the valve arrangement 7 opens and clears a hydraulic connection between the filling stage chamber 8 and the pressureless pressure medium container 9 via a chain of connecting ducts 20, 21, 22, 23. As a result, the pressure medium from the filling stage chamber 8 is expelled into the pressure medium container 9, and no longer into the pressure chamber 6, and the active area A1 is therefore switched to a hydraulically ineffective setting with respect to the buildup of brake pressure, or switched off, and the force-travel ratio at the piston 5 changes suddenly. From then on, the buildup of brake pressure in the pressure chamber 6 only takes place as result of the relatively small active area A2, and therefore overall in an incremental fashion.

In the inventive embodiment shown, the master brake cylinder 4 is embodied in a tandem design. In this context, a further front pressure chamber 19 which acts on a separate brake circuit (not shown) is arranged in the housing 11. A floating piston 18 is moveably guided between the pressure chambers 6 and 19, which floating piston 18 is usually actuated by the brake pressure in the pressure chamber 6, and is directly mechanically actuated by the piston 5 when there is a drop in pressure in the pressure chamber 6.

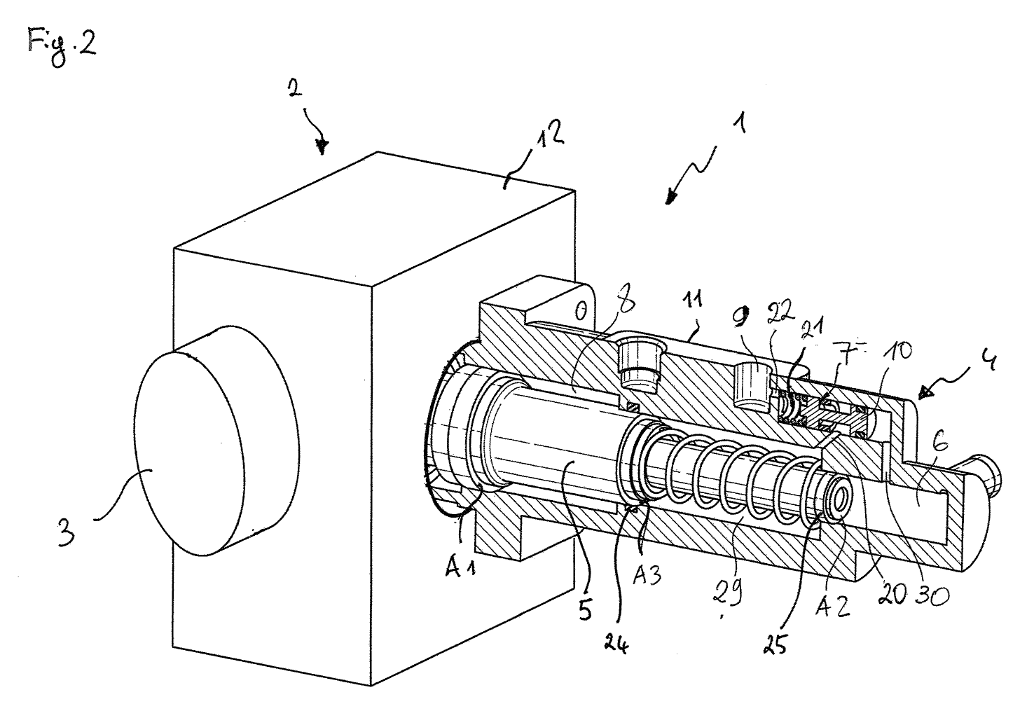

### FIG. 2:

FIG. 2 is a simplified illustration of another embodiment of an aspect of the inventive brake device. The master brake cylinder 4 is not embodied in a tandem design here, and has a single three-stage piston 5 which is equipped with 3 active areas A1, A2 and A3 which are of different sizes.

The valve arrangement 7 is integrated into the housing 11 of the master brake cylinder 4. The active area A1 expels the pressure medium from the filling stage chamber 8 into an intermediate chamber 29, where it is expelled further into the pressure chamber 6 by the active area A3. In this context, there is a flow over each of the seal elements 24 and 25 in the direction of the pressure chamber 6. The smallest active area A2 compresses the pressure medium in the pressure chamber 6 and expels it into a brake circuit connected thereto.

The brake pressure in the pressure chamber 6 is passed on through the drilled hole 30 to the spring-loaded valve piston 10, which, when a defined pressure value is reached, clears a hydraulic connection through the connecting ducts 20, 21 between the intermediate chamber 29 and the pressureless pressure medium container 9. As a result, the pressure medium from the filling stage chamber 8 and the intermediate chamber 29 is expelled into the pressure medium container 9, and the active areas A1 and A3 are switched to a hydraulically ineffective setting.

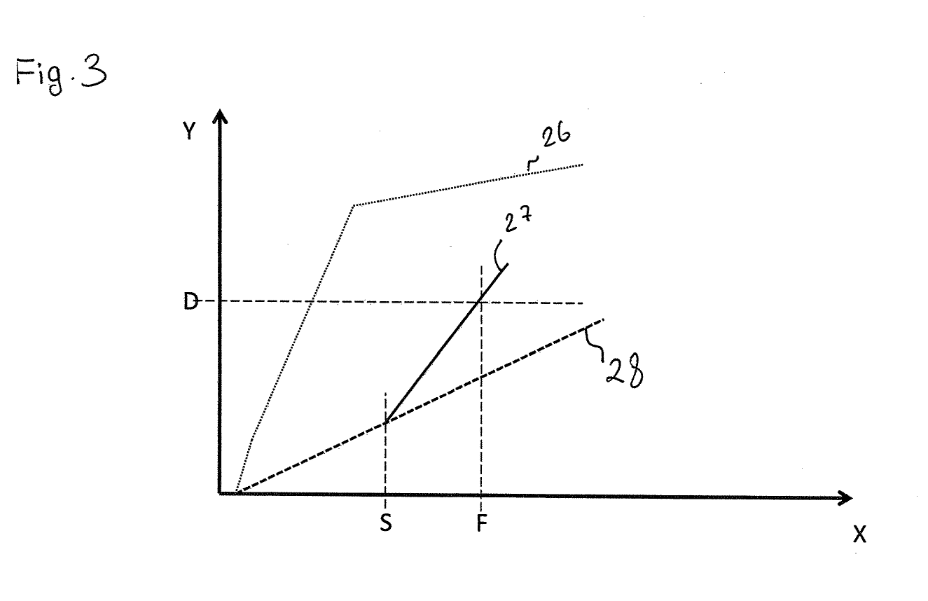

### FIG. 3:

FIG. 3 shows a diagram which basically illustrates the effectiveness of the brake device according to an aspect of the invention. The X axis stands for the necessary foot force on the brake pedal 13, and the Y axis for the braking deceleration of the vehicle. The perpendicular line F marks an upper limiting value for the foot force, for example a legally prescribed upper limit of 500N. The horizontal line D marks a defined target value for the braking deceleration of the vehicle, in particular a minimum value which is necessary for an emergency braking or full braking operation. The latter can also be legally prescribed and be, for example, of an order of magnitude of 0.643 g.

Graph 26 shows a profile of the foot force and the vehicle deceleration associated therewith given a satisfactory functioning brake booster 2 on a defined vehicle application. The foot force on the brake pedal 13 can be manipulated here in a targeted fashion by the regulation means of the brake booster 2 or by a separate stimulator unit, depending on the design.

In the case of failure of the brake booster 2 in the fall-back level, the brake deceleration depends, however, directly on the foot force. In the first phase of the braking operation the relatively large active area A1 is active. Although this permits a relatively short pedal travel, because a larger pressure medium volume is expelled, the foot force increases so quickly that a brake pressure which is necessary for the necessary braking deceleration D would not be reached within the upper limit of the foot force F, this is indicated by the graph 28.

When a defined brake pressure is reached, the active area A1 is switched off at the switching point S, with the result that only the relatively small active area A2 contributes to building up the brake pressure. As a result, the foot force increases only moderately and the target value for the brake deceleration D can be reached within the limiting value F. This is shown by graph 27.

### LIST OF REFERENCE SIGNS:

1 Brake device
2 Brake booster
3 Drive unit
4 Master brake cylinder
5 Piston
6 Pressure chamber
7 Valve arrangement
8 Filling stage chamber
9 Pressure medium container
10 Valve piston
11 Housing
12 Housing
13 Brake pedal
14 Coupling device
15 Coupling device
16 Sensor device
17 Electronic control unit
18 Floating piston
19 Pressure chamber
20 Connecting duct
21 Connecting duct
22 Connecting duct
23 Connecting duct
24 Seal element
25 Seal element
26 Graph of braking operation
27 Graph of fallback level with A2
28 Graph of fallback level with A1
29 Intermediate chamber
30 Drilled hole
A1, A2, A3 Active area
F Upper limit of foot force
D Target value of braking deceleration
S Switching point

1. A brake device for a hydraulic motor vehicle brake system, comprising:
an energy-store-free, electronically controlled brake booster,
an electric-motor-powered drive unit which is assigned to the brake booster,
wherein when the drive unit is activated the brake booster generates a boosted braking force, and when the drive unit is deactivated the brake booster does not generate any boosted braking force,
a master brake cylinder with at least one piston which can be displaced linearly therein and which bounds at least one pressure chamber filled with a pressure medium, in order to generate hydraulic brake pressure,
wherein in the case of a usual service braking operation the brake booster acts on the piston, and in the case of an unusual braking operation the muscle force of a driver acts thereon,
wherein at least one active area for generating brake pressure in the pressure chamber can be switched to a hydraulically ineffective setting under pressure control in the master brake cylinder, as a result of which the brake pressure in the pressure chamber is built up incrementally, and
wherein the active area is switched off by a valve arrangement which is controlled by the pressure in the pressure chamber.

2. The brake device as claimed in claim 1, wherein the active area is formed on the piston.

3. The brake device as claimed in claim 1, wherein the piston is embodied as a stepped piston with the active area and at least one further active area.

4. The brake device as claimed in claim 3, wherein the active area is made larger than the further active area.

5. The brake device as claimed in claim 1, wherein during a braking process, before it is switched off the active area expels the pressure medium from a filling stage chamber into the pressure chamber and expels said pressure medium into a pressureless pressure medium container after switching off has occurred.

6. The brake device as claimed in claim 1, wherein the valve arrangement comprises a spring-loaded valve piston which inevitably opens when there is a defined pressure in the pressure chamber.

7. The brake device as claimed in claim 5, wherein the valve arrangement blocks a hydraulic connection between the filling stage chamber and the pressure medium container.

8. The brake device as claimed in claim 1, wherein the valve arrangement is arranged integrated into the piston or into a housing of the master brake cylinder.

9. The brake device as claimed in claim 1, wherein the boosted braking force is generated hydraulically in the brake booster.

10. The brake device as claimed in claim 1, wherein the boosted braking force is generated mechanically in the brake booster.

11. The brake device as claimed in claim 1, wherein the boosted braking force is generated pneumatically in the brake booster.

12. The brake device as claimed in claim 1, wherein the master brake cylinder is embodied as a separate component and is mounted on a housing of the brake booster.
